(19) United States
(12) Patent Application Publication
(10) Pub. No.: US 2017/0073242 A1
(43) Pub. Date: Mar. 16, 2017

(54) REACTOR COMPRISING A VERTICALLY MOVABLE GAS LOCK

(71) Applicants: ThyssenKrupp Industrial Solutions AG, Essen (DE); ThyssenKrupp AG, Essen (DE)

(72) Inventor: Evgeni Gorval, Dortmund (DE)

(73) Assignees: ThyssenKrupp Industrial Solutions AG, Essen (DE); ThyssenKrupp AG, Essen (DE)

(21) Appl. No.: 15/311,141

(22) PCT Filed: May 15, 2015
(86) PCT No.: PCT/EP2015/060748

§ 371 Date: Nov. 14, 2016

(30) Foreign Application Priority Data
May 21, 2014 (DE) 10 2014 209 636.7

(51) Int. Cl. C01C 1/04

(52) U.S. Cl. CPC C01C 1/0447; C01C 1/0417

(57) ABSTRACT

A reactor for catalytic conversion of gas mixtures may include a catalyst bed. An upper side of the catalyst bed may include a gas lock that is movable in a vertical direction. The gas lock may be lowered when the catalyst bed contracts. In some examples, the gas lock prevents a gas mixture from flowing out of the catalyst bed via the upper side of the catalyst bed.

The invention relates to a reactor for the catalytic conversion of a gas mixture, preferably for catalytic ammonia synthesis from a gas mixture substantially comprising nitrogen and hydrogen, which comprises a catalyst bed, at least part of the upper side of the catalyst bed bearing a gas lock which is movable in the vertical direction, is lowered when the catalyst bed contracts and prevents the gas mixture from flowing out of the catalyst bed via its upper side.

Ammonia reactors usually comprise catalyst beds that are flowed through radially from the outside to the inside by a reacting gas mixture. Optimum utilization of the catalyst is achieved when the gas flow takes place uniformly over the entire height of the catalyst bed and without detours. The catalyst beds are usually provided as a loose charge, the catalyst particles with which they are charged tending over time to form a denser packing. As a consequence of this, the catalyst charge settles over time, which can amount to approximately 5% of the original height of the charge. As a result of the lowering of the upper side of the catalyst bed, zones that are free from catalyst are created above the catalyst bed in the form of voids, through which the gas mixture flows around the catalyst charge without reacting. As a result, there is a poorer ammonia yield.

The problem of shrinkage of the catalyst charge is known from the prior art. It has been proposed to counteract the shrinkage by chemical processes, in that the abrasion resistance and stability of the catalyst particles are improved, either by additives or by sintering. According to U.S. Pat. No. 3,560,167, layers of catalysts and inert materials are alternated. U.S. Pat. No. 3,195,988 discloses an ammonia reactor in which the catalyst is suspended in baskets. EP 374 564 and DE 3 643 726 relate to reactors with axial throughflow, in which not just one but three or four catalyst beds are arranged. According to DE 4 031 514, the problem of catalyst shrinkage in a reactor operated with syngas is solved by the upper free ends of the catalyst tubes being provided with supply hoppers, from which the catalyst is replenished. Such adding of additional catalyst of approximately 5% of the total amount, which is intended to make up for the settling, means however that there are higher costs (more catalyst, greater reactor volume). According to DE 4 216 661, the problem is solved with a pressure vessel which contains a catalyst bed and is passed through by heat exchanger tubes. U.S. Pat. No. 4,372,920 discloses a catalyst bed in which the upper part is flowed through axially-radially by the gas mixture, flow around the catalyst being prevented by an extended inner wall.

The invention is based on the object of providing advantageous reactors. The reactors should in particular ensure a high product yield, even when the catalyst bed is lowered over time.

This object is achieved by the subject matter of the patent claims.

The invention relates to a reactor for the catalytic conversion of a gas mixture, preferably for catalytic ammonia synthesis under increased pressure and at increased temperature from a gas mixture substantially comprising nitrogen and hydrogen, the reactor comprising a vessel, in which a catalyst bed is arranged between a lateral delimitation, preferably an inner delimitation, and a further lateral delimitation, preferably an outer delimitation; the lateral delimitation comprising a multiplicity of lateral gas inlets, via which the gas mixture can flow into the catalyst bed from the side through the lateral delimitation, in order to react there at least partly, preferably to form ammonia; and the further lateral delimitation comprising a multiplicity of lateral gas outlets, via which the gas mixture can subsequently flow out of the catalyst bed through the further lateral delimitation; and the upper side of the catalyst bed bearing a gas lock that is freely movable in the vertical direction. The gas lock is freely movable in the vertical direction and prevents the gas mixture from flowing out of the catalyst bed via its upper side.

The vessel of the reactor according to the invention preferably has a round cross-sectional area. It may be designed as a pressure vessel.

The reactor according to the invention is preferably intended to be set up vertically, so that the round cross-sectional area is aligned substantially horizontally. The main plane of extent of the gas lock is preferably likewise aligned substantially horizontally, to be precise substantially parallel to the upper side of the catalyst bed. The gas lock is borne by the upper side of the catalyst bed, i.e. it is pressed onto the upper side of the catalyst bed by gravitational force. The gas lock preferably floats loosely above the catalyst bed, preferably being in direct contact with the upper side of the catalyst bed. The gas lock prevents flow around the catalyst bed above its upper side, even after the settling of the catalyst charge. The vertical mobility of the gas lock has the effect of preventing a void through which the gas mixture could flow around the catalyst bed from forming between the underside of the gas lock and the upper side of the catalyst bed as a result of the settling of the catalyst charge.

The vertical movement of the gas lock may take place actively, for example by a spring. However, the gas lock is preferably lowered in the vertical direction by gravitational force alone when the catalyst bed contracts. In principle, the gas lock is preferably also raised by the catalyst bed in the vertical direction when the catalyst bed expands, but in practice this direction of movement is of secondary importance.

When the gas lock is vertically lowered as a result of the settling of the catalyst charge, according to the invention no (opened) gas outlets are arranged above the lowered gas lock in the further lateral delimitation, since otherwise the gas mixture could flow out of the catalyst bed via these gas outlets lying above the gas lock, bypassing the catalyst bed. For this reason, along its vertical extent, in its upper region, against which the gas lock preferably lies flush, the further lateral delimitation preferably

(i) does not comprise any gas outlets; or
(ii) comprises closed gas outlets, for example meshes of a metal basket, that are closed by suitable means (for example inner lying or outer lying metal plates) so that they can no longer act as gas outlets.

This means that the (opened) gas outlets in the further lateral delimitation are kept at a distance from the upper edge of the further lateral delimitation. A person skilled in the art recognizes that the extent of the distance of the (opened) gas outlets from the upper edge of the further lateral delimitation corresponds to the lowering of the gas lock that is to be expected as a result of the lowering of the catalyst bed. Since settling of the catalyst charge over time of up to approximately 5% of the original height of the charge can be expected, the extent of the distance of the (opened) gas outlets from the upper edge of the further lateral delimitation is preferably at least 5% of the total vertical extent of the further lateral delimitation, more preferably approximately 5% to approximately 15%, or approximately 5% to approximately 10%.

The gas inlets in the lateral delimitation are preferably not kept at a distance from the upper edge of the further lateral delimitation, i.e. they are preferably distributed uniformly or nonuniformly over the entire vertical extent of the lateral delimitation, in particular also in its upper region.

The main plane of extent of the gas lock is preferably arranged substantially orthogonal to the lateral delimitation and to the further lateral delimitation.

The lateral delimitation and the further lateral delimitation are preferably arranged substantially vertically parallel to one another. The lateral delimitation and the further lateral delimitation prevent the catalyst bed from breaking out laterally during charging and also during the operation of the reactor.

In the simplest case, the lateral delimitation and the further lateral delimitation are elements of the same component, for example of a basket into which the catalyst bed has been introduced as a charge. In this case, those elements of the component that comprise the multiplicity of lateral gas inlets should be understood as the lateral delimitation, and those elements of the component that comprise the multiplicity of lateral gas outlets should be understood as the further lateral delimitation. However, the lateral delimitation and the further lateral delimitation are preferably different components, preferably cylinders of different diameters, which are arranged concentrically in relation to one another about a common axis, so that the catalyst bed is arranged in the space between the outer side of the inner cylinder and inner side of the outer cylinder.

At the bottom, the catalyst bed is preferably borne by a gas-impermeable plate.

The type of catalyst depends on the gas phase reaction for which the reactor according to the invention is to be used. Ammonia synthesis usually takes place on iron catalysts, which are provided as particles (pellets) of a defined size.

The multiplicity of lateral gas inlets in the lateral delimitation and the multiplicity of lateral gas outlets in the further lateral delimitation of the reactor according to the invention are dimensioned such that the gas mixture can flow through in a controlled manner, the catalyst particles being held back. The inflow of the gas mixture into the catalyst bed can be influenced by the size and number of gas inlets per unit area of the lateral delimitation. By analogy, the outflow of the gas mixture from the catalyst bed can be influenced by the size and number of gas outlets per unit area of the further lateral delimitation.

In a preferred embodiment of the reactor according to the invention, the lateral delimitation and/or the further lateral delimitation is/are formed as a perforated plate. In this case, the holes in the lateral delimitation form the multiplicity of lateral gas inlets and the holes in the further lateral delimitation form the multiplicity of lateral gas outlets.

Differently perforated plates for the lateral delimitation and for the further lateral delimitation make it possible for the flow of the gas mixture through the catalyst bed to be made more uniform, and thereby to be improved. The number and/or size and/or arrangement of the gas inlets in or along the lateral delimitation preferably differ from the number and/or size and/or arrangement of the gas outlets in or along the further lateral delimitation, whereby the flow of the gas mixture through the catalyst bed can be made more uniform and the rate of conversion can thereby be increased. A difference in the arrangement can be achieved for example by a different distribution per unit area along the lateral delimitation or along the further lateral delimitation.

In a preferred embodiment, the gas inlets in the lateral delimitation are designed such that they produce a smaller flow resistance than the gas outlets in the further lateral delimitation. This can be achieved in the case of perforated plates for example by the number of holes per unit area being substantially the same for both lateral delimitations, but the holes in the lateral delimitation, i.e. the gas inlets, being larger than the holes in the further lateral delimitation, i.e. the gas outlets. Alternatively, this can be achieved with holes of substantially the same size, by the lateral delimitation comprising more holes, i.e. more gas inlets, per unit area than the further lateral delimitation comprises holes, i.e. gas outlets, per unit area.

In another preferred embodiment, the gas inlets in the lateral delimitation are designed such that they produce a greater flow resistance for the gas mixture than the gas outlets in the further lateral delimitation. This can be achieved in the case of perforated plates for example by the number of holes per unit area being substantially the same for both lateral delimitations, but the holes in the lateral delimitation, i.e. the gas inlets, being smaller than the holes in the further lateral delimitation, i.e. than the gas outlets. Alternatively, this can be achieved with holes of substantially the same size, by the lateral delimitation comprising fewer holes, i.e. fewer gas inlets, per unit area than the further lateral delimitation comprises holes, i.e. gas outlets, per unit area.

Not only may the gas inlets in the lateral delimitation differ with regard to size and number from the gas outlets in the further lateral delimitation. It is for instance also possible according to the invention that the gas inlets are distributed nonuniformly over the surface area of the lateral delimitation and the gas outlets are distributed nonuniformly over the surface area of the further lateral delimitation. It may thus be of advantage if the flow resistance for the gas mixture in the lower region, i.e. toward the bottom, is greater or less than in the upper region of the lateral delimitation or of the further lateral delimitation. In this way the effect can be achieved that the flow resistances along the lateral delimitation and along the further lateral delimitation are different.

The gas lock preferably does not extend over the entire surface area of the upper side of the catalyst bed, but is only borne by part of the upper side of the catalyst bed, i.e. on a partial area, whereby the other part of the upper side of the catalyst bed, by which the gas lock is not borne, remains free and forms an upper gas inlet, through which the gas mixture can additionally flow into the catalyst bed from above. According to this embodiment, the flow of the gas mixture into the catalyst bed may be understood as two partial flows, the one partial flow flowing into the catalyst bed laterally through the lateral delimitation via the multiplicity of lateral gas inlets and the other partial flow flowing into the catalyst bed from above via the upper gas inlet. This embodiment has proven to be particularly advantageous, since improved use of the catalyst is achieved in this way.

The gas lock is preferably dimensioned and arranged in such a way that, although the gas mixture can flow into the catalyst bed via the upper gas inlet, it cannot flow out, because it is prevented from doing so by the gas lock. For this purpose, the part of the upper side of the catalyst bed that does not bear the gas lock is preferably toward the lateral delimitation, and consequently the multiplicity of lateral gas inlets. For this purpose, an outer periphery of the gas lock preferably lies flush against the further lateral delimitation, so that the entire part of the upper side of the catalyst bed that does not bear the gas lock is toward the lateral delimitation, and consequently the multiplicity of lateral gas inlets. In this way it is ensured that the gas mixture additionally flowing into the catalyst bed from above through the upper gas inlet is taken up by the substantially horizontally running gas flow, which is caused by the lateral inflow of the gas mixture via the lateral gas inlets through the lateral delimitation. With the laterally radial flow through the catalyst bed that is preferred according to the invention, from the outside to the inside in the horizontal direction, the flow is encouraged to take this path in the case of an ammonia synthesis from hydrogen and nitrogen by the reaction being accompanied by a significant reduction in the amount of substance in the gas mixture, which has the consequent effect of a significant reduction in volume.

According to the invention, the transitional region at which an outer periphery of the gas lock preferably lies flush against the further lateral delimitation is not completely gas-tight. It has however been found that nor is this required for the effect according to the invention of the gas lock. It is thus sufficient if the gas lock opposes the gas mixture that is in the catalyst bed with a certain flow resistance.

The horizontal surface area of the gas lock in its main plane of extent is preferably 20% to 95%, more preferably 50% to 90%, still more preferably 60% to 85%, of the surface area of the upper side of the catalyst bed.

The gas lock may be produced from a single component. However, the gas lock preferably comprises a number of segments, for example at least 2, 3, 4, 5, 6, 7 or 8 preferably identical segments, two laterally adjacent segments in each case preferably overlapping horizontally. The segments are preferably connected to one another movably in such a way that, when there is vertical movement of the gas lock, the horizontal overlap of the segments is retained, and possibly even a canting of the gas lock is counteracted. This can be realized in various ways, and suitable measures are known to a person skilled in the art, for example screw couplings with play, i.e. with a freedom of movement of two segments engaging in one another or lying next to one another.

As a result of this freedom of movement, it is possible that the gas lock is not completely gas-tight between the individual segments. It has however been found that nor is this required for the effect according to the invention of the gas lock. It is thus sufficient if the gas lock opposes the gas mixture that is in the catalyst bed with a certain flow resistance.

In a particularly preferred embodiment of the reactor according to the invention, the lateral delimitation forms an outer cylinder and the further lateral delimitation forms an inner cylinder, the inner cylinder being arranged concentrically within the outer cylinder about a common central axis. According to this embodiment, the catalyst bed is arranged between the inner wall of the outer cylinder and the outer wall of the inner cylinder. The vessel preferably has a substantially circular cross-sectional area, the outer cylinder being arranged concentrically within the vessel about a common central axis, with the effect of forming between the inner wall of the vessel and the outer wall of the outer cylinder an annular gap through which the gas mixture can flow to the multiplicity of lateral gas inlets in the outer cylinder. This annular gap preferably has a width of at least 5 cm, more preferably at least 10 cm, particularly preferably 10 cm to 40 cm. The multiplicity of lateral gas inlets are preferably arranged in the wall of the outer cylinder, so that the gas mixture can flow from the annular gap into the catalyst bed radially from the side via the multiplicity of lateral gas inlets through the wall of the outer cylinder, in order to react there at least partly. By analogy, the multiplicity of lateral gas outlets are arranged in the wall of the inner cylinder, so that the gas mixture can subsequently flow radially out of the catalyst bed via the multiplicity of lateral gas outlets through the wall of the inner cylinder into an inner cavity, which is formed by the inner cylinder and via which the gas mixture can be discharged. This cavity may be understood as a manifold. The multiplicity of lateral gas inlets and the multiplicity of lateral gas outlets make possible a controlled uniform radial flow of the gas mixture into the reactor bed from the outside and subsequently out of the reactor bed toward the inside into the cavity. The multiplicity of lateral gas inlets are preferably distributed over the entire vertical extent of the wall of the outer cylinder, so that there are in particular also lateral gas inlets in its upper region. This makes it possible that the gas mixture can also flow laterally through the gas inlets into the catalyst bed in the upper region of the outer cylinder. As a difference from this, the multiplicity of lateral (opened) gas outlets are preferably not distributed over the entire vertical extent of the wall of the inner cylinder, but instead in the upper region are kept at a distance from its upper edge. The gas lock moves along this upper region of the inner cylinder when the catalyst bed contracts.

The gas lock preferably has the form of an annular disk, which is possibly divided into a number of overlapping segments, the inner periphery of the annular disk preferably lying flush against the outer wall of the inner cylinder. In this case, the main plane of extent of the annular disk and the vertical axis of extent of the inner cylinder are preferably arranged substantially orthogonal to one another, the annular disk being movable in the direction of the vertical axis of extent of the inner cylinder along the outer wall of the inner cylinder.

In the case of this particularly preferred embodiment of the reactor according to the invention, the vessel, the outer cylinder, the inner cylinder and the annular disk are preferably arranged concentrically in relation to one another about a common axis.

The cavity formed by the inner cylinder preferably has internal components, for example a mixing element and/or a heat exchanger and/or a further cylinder, which deflects the gas flow emerging from the reactor bed (deflecting tube). This is of advantage for regulating the flow and for a heat exchange. The upper edge of the further cylinder is preferably kept at a distance from the upper side of the upwardly closed cavity, so that the gas mixture flowing out of the multiplicity of lateral gas outlets into the cavity first flows upward in an annular gap, which is formed by the inner side of the inner cylinder and the outer side of the further cylinder, then is deflected and finally flows downward along the inner side of the further cylinder, possibly through the internal components that are present, preferably a heat exchanger, where it preferably leaves this part of the reactor. In the case of this particularly preferred embodiment of the reactor according to the invention, the vessel, the outer cylinder, the inner cylinder, the further cylinder and the annular disk are preferably arranged concentrically in relation to one another about a common axis.

The outer periphery of the annular disk preferably describes at least virtually a circle which is smaller than the circle that is described by the inner wall of the outer cylinder, with the effect of forming between the inner wall of the outer cylinder and the outer periphery of the annular disk a further annular gap, which acts as an upper gas inlet through which the gas mixture can additionally flow into the catalyst bed from above. This further annular gap preferably has a width of at least 4 cm, more preferably at least 10 cm, particularly preferably 5 cm to 21 cm.

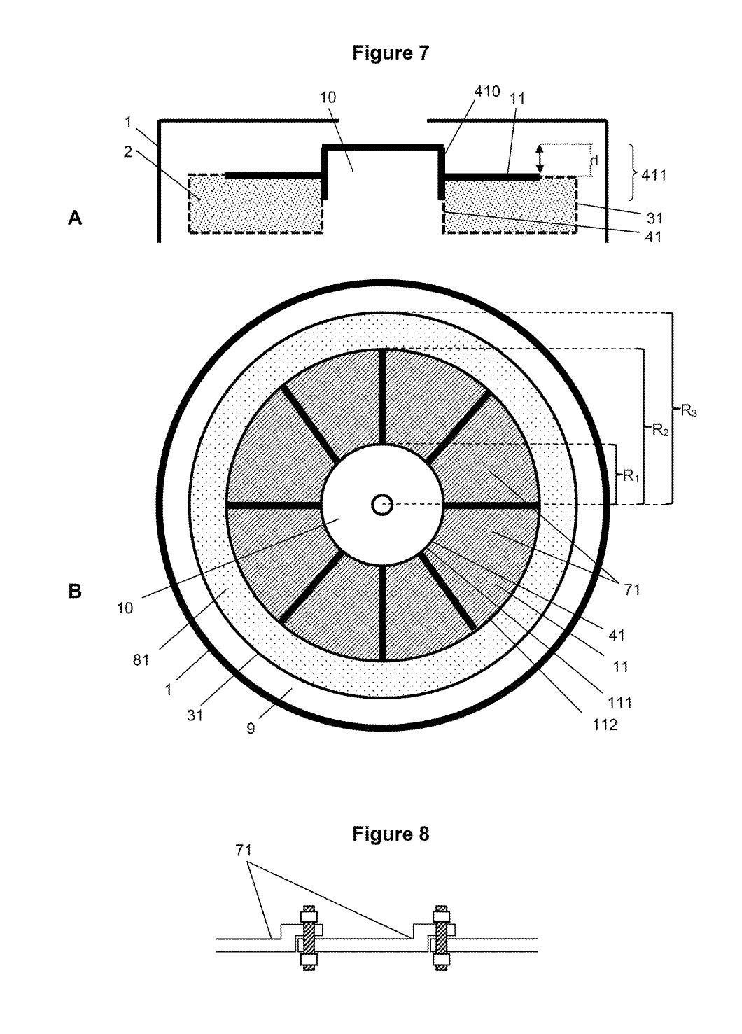

The inner periphery of the annular disk preferably describes at least virtually a circle with a radius R₁; the outer wall of the inner cylinder, against which the inner periphery of the annular disk lies flush, describing at least virtually a circle with a radius that corresponds substantially to the radius R₁; the outer periphery of the annular disk describing at least virtually a circle with a radius R₂, so that the surface area (F₁) of the annular disk in its main plane of extent is given by the difference F₁=π(R₂²−R₁²) (cf. FIG. 7B); the inner wall of the outer cylinder describing at least virtually a circle with a radius R₃, so that the surface area (F₂) of the further annular gap, which acts as an upper gas inlet, is given by the difference F₂=π(R₃²−R₂²) (cf. FIG. 7B); and one of the following two conditions being satisfied: F₁≧F₂, or F₁<F₂. The condition F₁>F₂ is preferably satisfied, i.e. the partial area of the upper side of the catalyst bed that bears the annular disk as a gas lock is greater than the other partial area of the upper side of the catalyst bed that acts as an upper gas inlet. One of the following conditions: F₁≧1.5·F₂, F₁≧2·F₂, F₁≧2.5·F₂, or F₁≧3·F₂ is preferably satisfied.

In a preferred embodiment, in an upper region, against which the inner periphery of the annular disk lies, the inner cylinder

(i) does not comprise any gas outlets; or
(ii) comprises closed gas outlets that are closed in a flush and sleeve-like manner by a concentrically arranged closure, preferably in the form of a short tube lying on the inside or the outside, so that they no longer act as gas outlets.

A person skilled in the art recognizes that the extent of the distance of the (opened) gas outlets from the upper edge of the inner cylinder corresponds to the lowering of the gas lock that is to be expected as a result of the lowering of the catalyst bed. Since settling of the catalyst charge over time of up to approximately 5% of the original height of the charge can be expected, the extent of the distance of the (opened) gas outlets from the upper edge of the inner cylinder is preferably at least 5% of the total vertical extent of the further lateral delimitation, more preferably approximately 5% to approximately 15%, or approximately 5% to approximately 10%.

As a difference from this, the outer cylinder preferably also comprises gas inlets in an upper region, which is arranged substantially parallel to the aforementioned upper region of the inner cylinder, so that the gas mixture can flow radially into the upper region of the catalyst bed laterally through these gas inlets.

A further aspect of the invention relates to an ammonia converter, which comprises at least two, preferably three, reactors according to the invention arranged one above the other in a common pressure vessel. The reactors according to the invention preferably comprise in each case a vessel, an outer cylinder, an inner cylinder and also an annular disk, which are respectively arranged concentrically about a common axis. The diameters of the vessels and of the outer cylinders are preferably substantially the same in the case of all the reactors, but the diameters of the inner cylinders of the upper reactor and of the lower reactor are preferably different. The arrangement of the reactors is preferably provided in such a way that the upper reactor is flowed through first by the gas mixture, followed by the lower reactor. The lower reactor preferably fulfills the purpose of converting reactants contained in the gas mixture that have not yet reacted after passing through the upper reactor. The reaction conditions, in particular the reaction temperature, can be controlled, preferably independently, in the reactors.

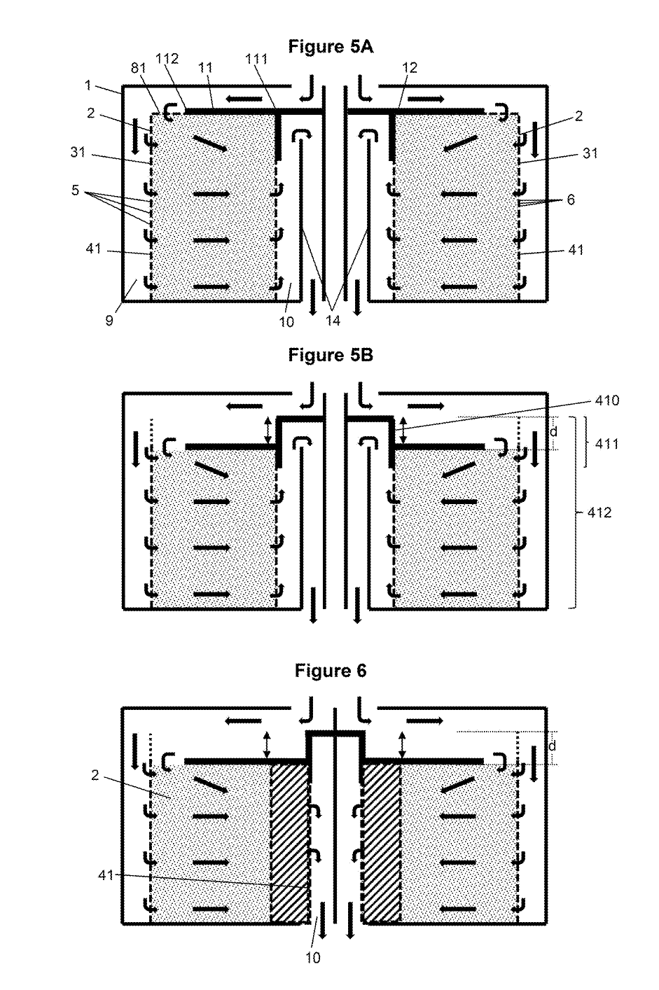

The upper reactor is preferably designed as illustrated in FIGS. 5A/B and comprises within the inner cylinder an upwardly closed cavity, in which a heat exchanger and a further cylinder are arranged, the upper edge of the further cylinder being kept at a distance from the upper side of the upwardly closed cavity, so that the gas mixture flowing out of the multiplicity of lateral gas outlets into the cavity can first flow upward between the inner side of the inner cylinder and the outer side of the further cylinder, then be deflected and finally can flow along the inner side of the further cylinder downward to the lower reactor.

The lower reactor is preferably designed as illustrated in FIG. 6 and likewise comprises within the inner cylinder an upwardly closed cavity, in which however, as a difference from the upper reactor, neither a heat exchanger nor a further cylinder is arranged, so that the gas mixture flowing out of the multiplicity of lateral gas outlets into the cavity can flow downward without being deflected; and the diameter of the inner cylinder of the lower reactor being less than the diameter of the inner cylinder of the upper reactor, whereby the inner radial extent of the catalyst bed in the lower reactor is greater than in the upper reactor. In an alternative embodiment, the lower reactor comprises an upwardly closed cavity, in which a further cylinder is likewise arranged, but as a difference from the upper reactor no heat exchanger, so that the gas mixture flowing out of the multiplicity of lateral gas outlets into the cavity can first flow upward between the inner side of the inner cylinder and the outer side of the further cylinder, then be deflected and finally can flow downward out of the lower reactor along the inner side of the further cylinder.

If the ammonia converter according to the invention comprises three reactors according to the invention that are arranged one above the other, the middle reactor is preferably designed in a way corresponding to the upper reactor, in particular likewise comprises internal components in the cavity, specifically a mixing element, a heat exchanger and a further cylinder, the upper reactor and the middle reactor not having to be entirely identical in construction however.

The invention is illustrated by way of example and schematically on the basis of the figures. A person skilled in the art recognizes that, in the case of a reactor according to the invention or an ammonia converter according to the invention, not necessarily all of the features that are depicted in the figures have to be realized at the same time. In the figures, arrows indicate the local direction of flow of the gas mixture during the operation of the respective reactor.

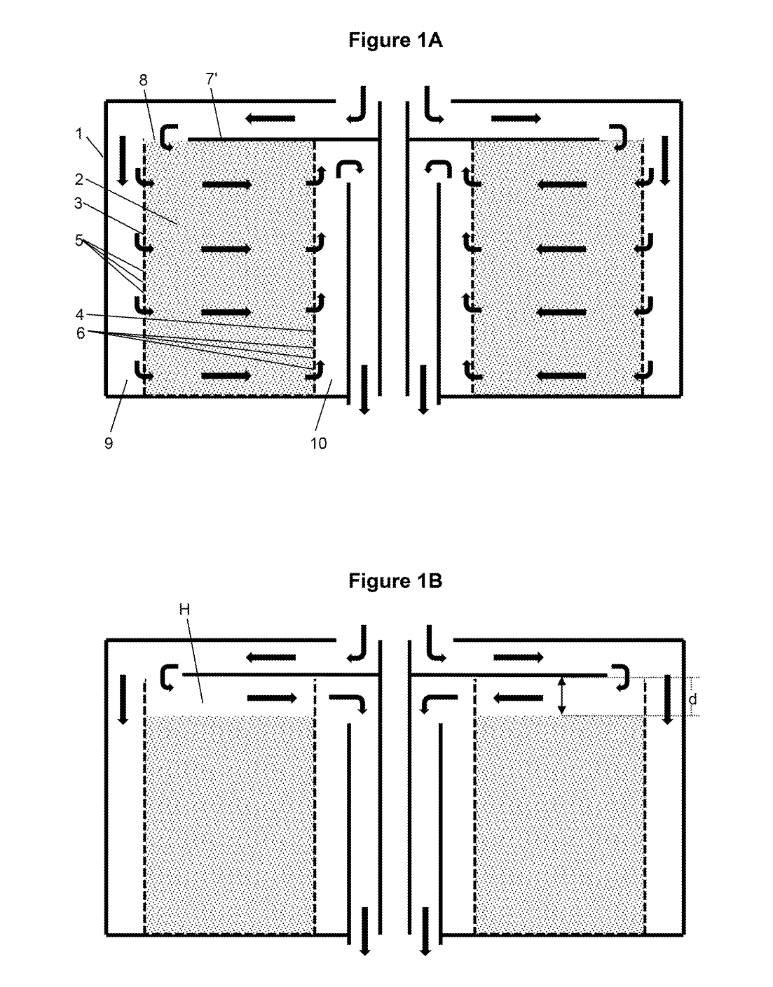

FIG. 1 schematically illustrates the problems that may occur in the case of conventional ammonia reactors as a result of the lowering of the catalyst bed. FIG. 1A shows as a side view a section through a conventional reactor in the state in which it is originally filled with catalyst. The direction of flow of the gas mixture, which substantially comprises nitrogen and hydrogen, is indicated by arrows. The reactor comprises a vessel (1), in which a catalyst bed (2) is arranged between a lateral delimitation (3) and a further lateral delimitation (4). The cylindrical reactor (1), the lateral delimitation (3) and the further lateral delimitation (4) are in each case cylindrical and are arranged concentrically in relation to one another about a common central axis. The lateral delimitation (3) comprises a multiplicity of lateral gas inlets (5). Formed between the inner wall of the vessel (1) and the lateral delimitation (3) is a first annular gap (9), through which the gas mixture can flow from above along the outer side of the lateral delimitation (3) to the multiplicity of lateral gas inlets (5) in the lateral delimitation (3), via which the gas mixture can subsequently flow into the catalyst bed (2) from the side. Part of the upper side of the catalyst bed (2) is closed by an immovable upper delimitation (7′), which is impermeable to the gas mixture. The other part of the upper side of the catalyst bed (2) forms an upper gas inlet (8) in the form of a second annular gap, through which the gas mixture can additionally flow into the catalyst bed (2) from above, in order to react there at least partly, to form ammonia. The further lateral delimitation (4) comprises a multiplicity of lateral gas outlets (6), via which the gas mixture can subsequently flow out of the catalyst bed (2) into an inner cavity (10), which is formed by the further lateral delimitation (4) and via which the gas mixture can be discharged. FIG. 1B shows the same conventional ammonia reactor in a state in which the catalyst bed (2) has shrunk, so that the upper side of the catalyst bed (2) has been lowered by the distance d. This has had the effect of creating between the upper side of the catalyst bed (2) and the underside of the immovable upper delimitation (7′) a void (H), through which a large part of the gas mixture flows without thereby coming into contact with the catalyst bed (2). The consequence is significant losses in the rate of conversion in the ammonia synthesis.

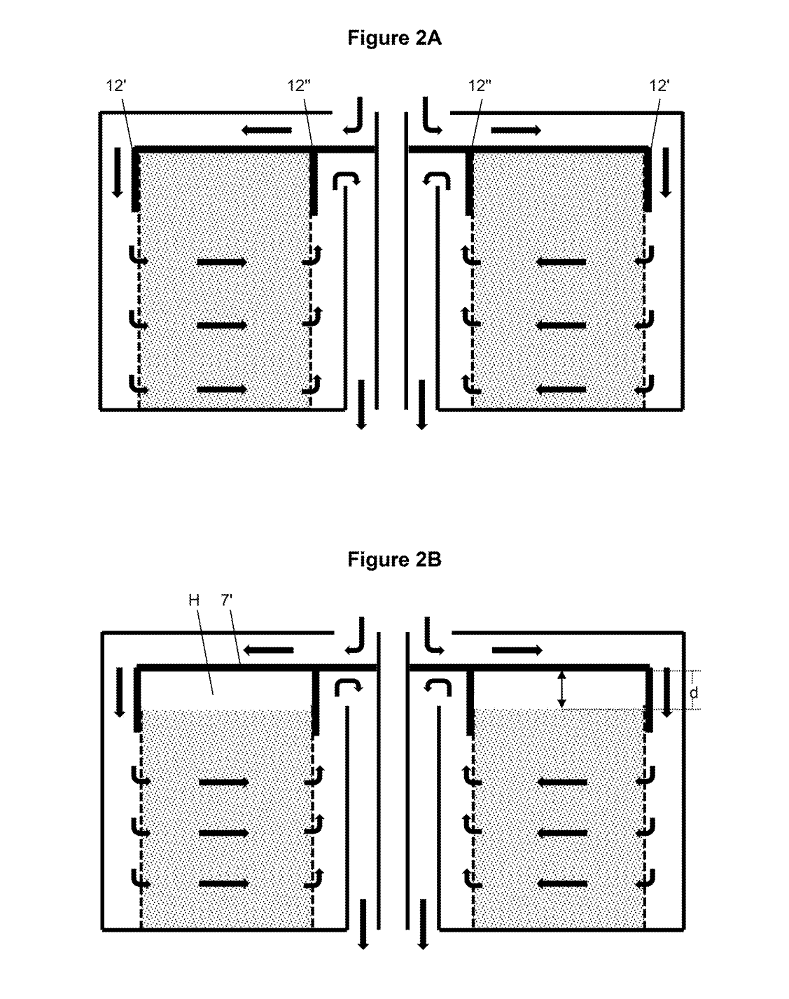

FIG. 2 illustrates a conventional solution to this problem that is represented in FIG. 1, the reactor according to FIG. 1 having been modified in such a way that the lateral delimitation (3) is concentrically surrounded in the upper region in the manner of a sleeve by a lateral closure in the form of a short tube (12′) and the further lateral delimitation (4) is concentrically surrounded in the upper region in the manner of a sleeve by a lateral closure in the form of a short tube (12″). Because of the short tube (12′), in this upper region the gas mixture cannot flow laterally into the catalyst bed (2) and, because of the short tube (12″), in this upper region the gas mixture also cannot flow out of the catalyst bed (2). FIG. 2A shows as a lateral view a section through this conventional reactor in the state in which it is originally filled with catalyst. FIG. 2B shows the same conventional reactor in a state in which the catalyst bed (2) has shrunk, so that the upper side of the catalyst bed (2) has been lowered by the distance d. This has had the effect of creating a void (H) between the upper side of the catalyst bed (2) and the underside of the immovable upper delimitation (7′). This void (H) is closed off by the immovable upper delimitation (7′), the short tube (12′) and the short tube (12″) in such a way that the gas mixture practically does not penetrate into the void (H), while bypassing the catalyst bed (2). This conventional solution has the disadvantage however that a considerable amount of the catalyst, which is surrounded by the immovable upper delimitation (7′), the short tube (12′) and the short tube (12″), remains practically unused, i.e. cannot develop its catalytic effect, because this amount of catalyst practically does not come into contact with the gas mixture when the catalyst has not shrunk.

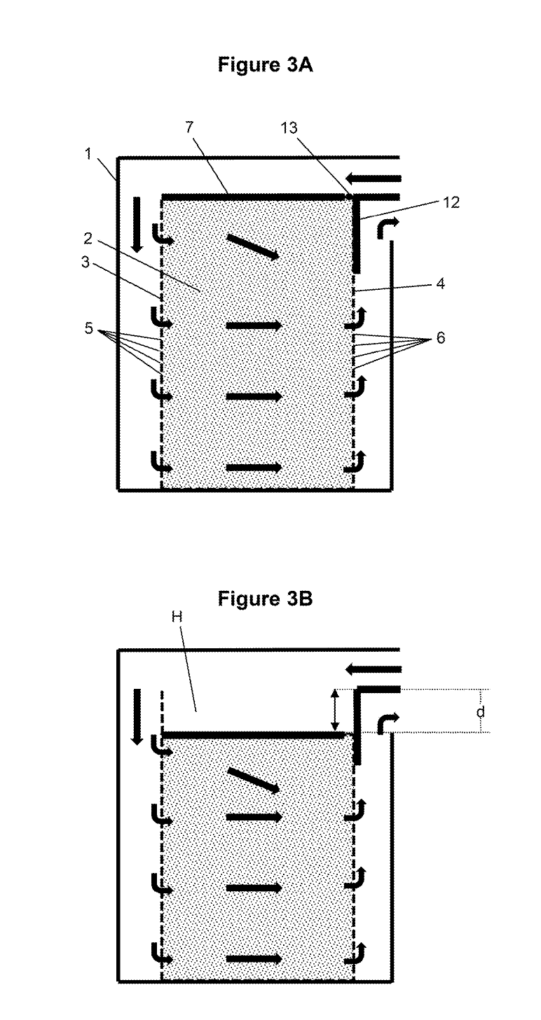

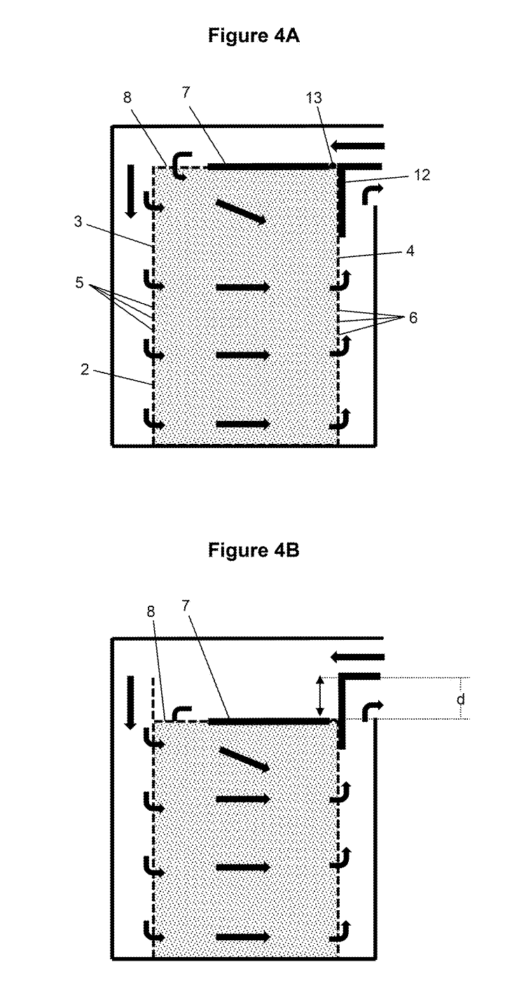

FIG. 3 illustrates in a simplified form the operating principle of a reactor according to the invention, which comprises a vessel (1) in which a catalyst bed (2) is arranged between a lateral delimitation (3) and a further lateral delimitation (4). The lateral delimitation (3) comprises a multiplicity of lateral gas inlets (5), via which the gas mixture can flow into the catalyst bed (2) from the side through the lateral delimitation (3), in order to react there at least partly, to form ammonia. The further lateral delimitation (4) comprises a multiplicity of lateral gas outlets (6), via which the gas mixture can subsequently flow out of the catalyst bed (2) through the further lateral delimitation (4). In the upper region, the further lateral delimitation (4) does not comprise any lateral gas outlets (6). This may be achieved for example by the lateral gas outlets (6) simply being omitted in the upper region of the further lateral delimitation (4). Alternatively, however, this may for example also be achieved as shown in FIG. 4, by a lateral closure (12) on the inner side or the outer side of the further lateral delimitation (4) closing any gas outlets (6) there may be, so that they can no longer act as a gas outlet. The upper side of the catalyst bed (2) bears a gas lock (7), which is movable in the vertical direction and preferably prevents the gas mixture from flowing out of the catalyst bed (2) via its upper side. The gas lock (7) is movable in the vertical direction along the further lateral delimitation (4) and thereby finishes preferably flush against the further lateral delimitation (4); which is preferably assisted by a contact element (13). FIG. 3A shows as a side view a section through this reactor according to the invention in the state in which it is originally filled with catalyst. FIG. 3B shows the same reactor according to the invention in a state in which the catalyst bed (2) has shrunk, so that the upper side of the catalyst bed (2) has been lowered by the distance d. Since the gas lock (7) is movable in the vertical direction, it continues as before to be borne by the upper side of the catalyst bed (2) and consequently has been lowered by the distance d along the further lateral delimitation (4). The gas lock (7) finishes as before flush against the further lateral delimitation (4), possibly assisted by the contact element (13). The forming of a void H underneath the upper delimitation (7′), as in the case of the conventional reactors according to FIGS. 1A/B and 2A/B, is thereby prevented. Because of the gas lock (7), the gas mixture cannot escape from the catalyst bed (2) via its upper side and the total amount of catalyst is used for the ammonia synthesis.

FIG. 4 illustrates in a simplified form a preferred embodiment of the reactor according to the invention. In this case, the vertically movable gas lock (7) is not borne by the entire upper side of the catalyst bed (2), but merely by part of the upper side of the catalyst bed (2) that is toward the further lateral delimitation (4) with the lateral gas outlets (6). The part of the upper side of the catalyst bed (2) that is toward the lateral delimitation (3) with the lateral gas inlets (5) is not closed by the gas lock (7) and consequently acts as an upper gas inlet (8), via which the gas mixture can additionally flow into the reactor bed (2), in order to react there at least partly, to form ammonia. This embodiment has the advantage that the proportion of the catalyst that is arranged in the upper region between the lateral delimitation (3) and the lateral closure (12) is flowed through even better by the gas mixture. The gas lock (7) is movable in the vertical direction along the further lateral delimitation (4) and thereby finishes preferably flush against the further lateral delimitation (4), which is preferably assisted by a contact element (13), for example a collar-like sleeve. FIG. 4A shows as a side view a section through this reactor according to the invention in the state in which it is originally filled with catalyst. FIG. 4B shows the same reactor according to the invention in a state in which the catalyst bed (2) has shrunk, so that the upper side of the catalyst bed (2) has been lowered by the distance d. Also in this state, the part of the upper side of the catalyst bed (2) that is toward the lateral delimitation (3) with the lateral gas inlets (5) continues as before to act as an upper gas inlet (8).

FIG. 5 illustrates in a simplified form a further preferred embodiment of the reactor according to the invention, which with regard to the vessel (1), the catalyst bed (2), the lateral delimitation (3) and the further lateral delimitation (4) is preferably constructed substantially radially symmetrically about a common central axis. In this case, the lateral delimitation (3) forms an outer cylinder (31) and the further lateral delimitation (4) forms an inner cylinder (41), the inner cylinder (41) being arranged concentrically within the outer cylinder (31) about a common central axis. The catalyst bed (2) is arranged between the inner wall of the outer cylinder (31) and the outer wall of the inner cylinder (41). The vessel (1) comprises substantially circular cross-sectional areas, the outer cylinder (31) being arranged concentrically within the vessel (1) about a common central axis, with the effect that between the inner wall of the vessel (1) and the outer wall of the outer cylinder (31) there is formed an annular gap (9), through which the gas mixture can flow to the multiplicity of lateral gas inlets (5) in the outer cylinder (31). The multiplicity of lateral gas inlets (5) is preferably arranged in the wall of the outer cylinder (31), so that the gas mixture can flow from the annular gap (9) radially into the catalyst bed (2) from the side via the multiplicity of lateral gas inlets (5) through the wall of the outer cylinder (31), in order to react there at least partly, to form ammonia. The multiplicity of lateral gas outlets (6) are preferably arranged in the wall of the inner cylinder (41), so that the gas mixture can subsequently flow radially out of the catalyst bed (2) via the multiplicity of lateral gas outlets (6) through the wall of the inner cylinder (41) into an inner cavity (10), which is formed by the inner cylinder (41) and via which the gas mixture can be discharged. The gas lock (7) preferably has the form of an annular disk (11), which is possibly divided into a number of overlapping segments, the inner periphery (111) of the annular disk (11) preferably lying flush against the outer wall of the inner cylinder (41). The outer periphery (112) of the annular disk (11) preferably describes at least virtually a circle which is smaller than the circle that is described by the inner wall of the outer cylinder (31), with the effect of forming between the inner wall of the outer cylinder (31) and the outer periphery (112) of the annular disk (11) an annular gap (81), which acts as an upper gas inlet (8) through which the gas mixture can additionally flow into the catalyst bed (2) from above. The inner cylinder (41) has a total vertical extent (412) and is flanked in its upper region (410) by a lateral closure (12), which takes the form of a short tube (12), which is arranged inside the inner cylinder (41) and finishes flush against the inner side of the inner cylinder (41), so that over the entire vertical extent (411) of the upper region (410) of the inner cylinder (41) no gas mixture can pass from the catalyst bed into the cavity (10). Such a flow of the gas mixture from the catalyst bed (2) into the cavity (10) is only made possible by the multiplicity of lateral gas outlets (6), which are arranged in the wall of the inner cylinder (41) below its upper region (410). The vertical extent (411) of the upper region (410) of the inner cylinder (41) is preferably at least 5%, or preferably approximately 5% to approximately 15%, or approximately 5% to approximately 10%, of the total vertical extent (412) of the inner cylinder (41). The cavity (10) preferably comprises internal components, preferably a mixer and a further cylinder (14), which deflects the gas flow emerging from the reactor bed (2) (deflecting tube), which is of advantage for regulating the flow and for a heat exchange. The upper edge of the further cylinder (14) is preferably kept at a distance from the upper side of the upwardly closed cavity (10), so that the gas mixture flowing out of the multiplicity of lateral gas outlets (6) into the cavity (10) first flows upward in an annular gap, which is formed by the inner side of the inner cylinder (41) and the outer side of the further cylinder (14), then is deflected and finally flows downward along the inner side of the further cylinder (14). FIG. 5A shows as a side view a section through this reactor according to the invention in the state in which it is originally filled with catalyst. FIG. 5B shows the same reactor according to the invention in a state in which the catalyst bed (2) has shrunk, so that the upper side of the catalyst bed (2) has been lowered by the distance d. Also in this state, the annular gap (81) acts as before as an upper gas inlet (8).

FIG. 6 illustrates in a simplified form a preferred variant of the reactor according to the invention, here already in the state in which the catalyst bed (2) has shrunk, so that the upper side of the catalyst bed (2) has been lowered by the distance d. As a difference from the embodiment according to FIG. 5B, the inner cavity (10), which is formed by the inner cylinder (41), is configured in a more space-saving manner without internal components, in particular without a further cylinder (14). This embodiment is preferred in particular whenever no heat exchanger is provided in the inner cavity (10) in order to carry away the heat of reaction that is produced. Omitting the internal components, in particular the further cylinder (14), in the inner cavity has the effect that the diameter of the inner cylinder (41) is smaller, whereby the catalyst bed (2) can be correspondingly increased in size (represented in FIG. 6 as a hatched area).

FIG. 7 illustrates in a simplified form a variant of the preferred embodiment of the reactor according to the invention according to FIG. 6. In this case, FIG. 7A is a side view in section through the reactor according to the invention already in the state in which the catalyst bed (2) has shrunk, so that the upper side of the catalyst bed (2) has been lowered by the distance d. FIG. 7B is a plan view in section through the reactor according to the invention. The inner cylinder (41) is flanked in its upper region (410) by a lateral closure (12), which takes the form of a short tube (12) which is arranged inside the inner cylinder (41) and finishes flush against the inner side of the inner cylinder (41), so that over the entire vertical extent (411) of the upper region (410) of the inner cylinder (41) no gas mixture can pass from the catalyst bed into the cavity (10). Such a flow of the gas mixture from the catalyst bed (2) into the cavity (10) is only made possible by the multiplicity of lateral gas outlets (6), which are arranged in the wall of the inner cylinder (41) below its upper region (410). The gas lock (7) borne by the upper side of the catalyst bed (2) is formed as an annular disk (11), which comprises an inner periphery (111) and an outer periphery (112) and is made up of a number of segments (71) (eight shown here), which preferably overlap. The inner periphery (111) of the annular disk (11) preferably lies flush against the outer wall of the inner cylinder (41). The outer periphery (112) of the annular disk (11) preferably describes at least virtually a circle which is smaller than the circle that is described by the inner wall of the outer cylinder (31), with the effect of forming between the inner wall of the outer cylinder (31) and the outer periphery (112) of the annular disk (11) an annular gap (81), which acts as an upper gas inlet (8) through which the gas mixture can additionally flow into the catalyst bed (2) from above. The annular disk (11) is movable in the vertical direction along the outer wall of the outer cylinder (41) and thereby finishes preferably flush against it.

FIG. 8 illustrates in a simplified form a preferred embodiment of the annular disk (11) comprising a number of overlapping segments (71), the segments (71) being connected to one another movably in such a way that, when there is vertical movement of the gas lock (7), the horizontal overlap of the segments (71) is retained. The connection may be realized for example by screws, rivets, wire and the like.

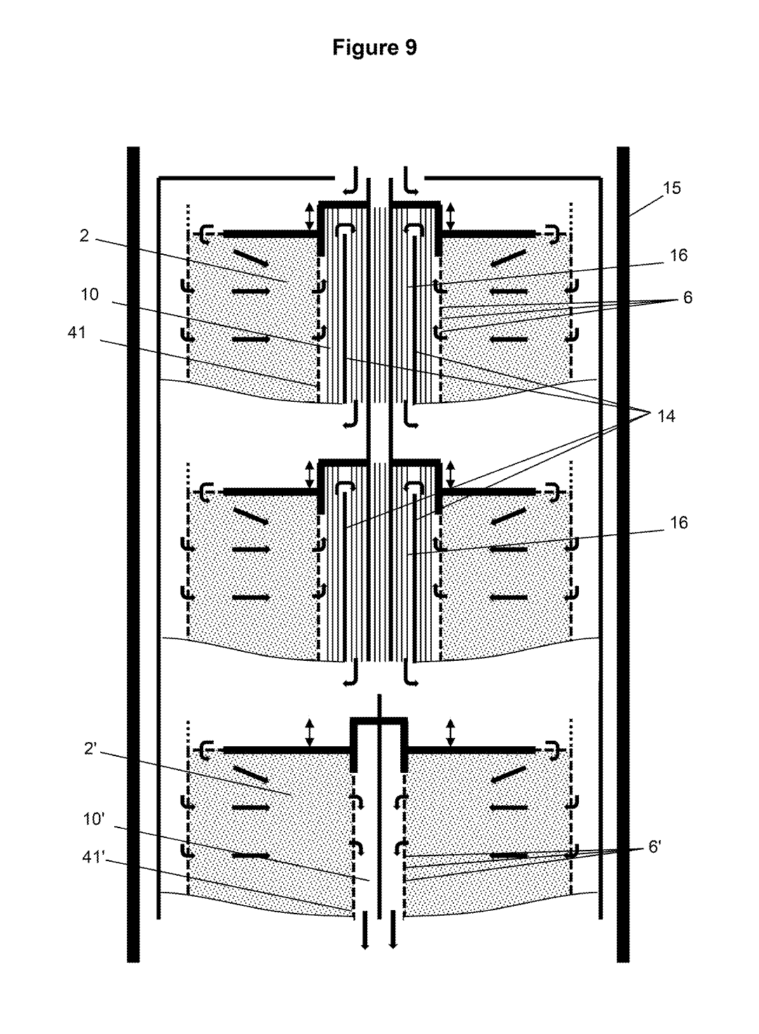

FIG. 9 illustrates in a simplified form an overall arrangement of three reactors according to the invention in a common pressure vessel (15), which form an ammonia converter. The two upper reactors are in this case reactors according to the invention, as also represented for example in FIGS. 5A/B. Arranged in the cavity (10), which is formed by the inner cylinder (41), there is in each case in addition to a further cylinder (14) also a heat exchanger (16). The lower reactor is likewise a reactor according to the invention, as also represented for example in FIG. 6. As a difference from the two upper reactors, in the lower reactor the inner cavity (10′), which is formed by the inner cylinder (41′), is configured however in a more space-saving manner without internal components, in particular without a further cylinder and without a heat exchanger. This has the effect that the diameter of the inner cylinder (41′) is smaller, whereby the catalyst bed (2) is correspondingly increased in size in the radially inward direction. In a preferred embodiment, the lower reactor is configured with the further cylinder (14). It is however alternatively likewise possible according to the invention to design the inner cavity (10′) in the lower reactor in a way analogous to the two upper reactors, i.e. likewise with internal components, in particular with a further cylinder (14′) (not represented in FIG. 9), but preferably without a heat exchanger.

A further aspect of the invention relates to a method for catalytic ammonia synthesis, a gas mixture substantially comprising nitrogen and hydrogen being made to react under increased pressure and at increased temperature in a reactor according to the invention described above or in an ammonia converter described above.

### EXAMPLE

The advantages of the reactor according to the invention or of the ammonia converter according to the invention were verified by simulation calculations. The simulation software FLUENT® was used for this. Apart from the flow equations, these calculations also take into account the reaction kinetics and the heat transfer, so that a quantitative assessment of the structural modification is possible.

A conventional ammonia converter with a capacity of 1200 t NH₃/d was used for purposes of comparison. This reference converter comprised three reactors lying one above the other with in each case a catalyst bed, the upper reactor (reactor 1) and the middle reactor (reactor 2) being formed with a heat exchanger and all three reactors comprising in the cavity that was formed by the inner cylinder a further cylinder as a deflecting tube (for the deflecting tube, cf. FIGS. 5 and 9, reference numeral (14)). Separate FLUENT calculations were not carried out for reactor 1 and reactor 2. The amount of gas at the inlet into the catalyst bed of reactor 1 was 596149 Nm³/h. The inlet and outlet conditions for the three catalyst beds of this reference converter are summarized in the following table:

| | |
|---|---|
| Inlet | Outlet |

| | T | % by vol. | T | % by vol. |
|---|---|---|---|---|
| | [° C.] | NH₃ | [° C.] | NH₃ |
| 1st catalyst bed | 400.0 | 3.01 | 506.5 | 9.73 |
| 2nd catalyst bed | 438.2 | 9.73 | 479.2 | 13.31 |
| 3rd catalyst bed | 424.3 | 13.31 | 457.2 | 15.83 |

The ammonia converter according to the invention was structurally modified by individual measures (cf. FIG. 9).

Structural modifications only for reactor 3 (also in the case of the reference converter without a heat exchanger):
a) omission of the deflecting tube, filling the volume that has become free with catalyst, unhindered outflow;
b) as under a), in addition differently perforated plates at the inlet and outlet of the catalyst bed.

Structural modifications for all three reactors:
c) providing loose, floating segments of the circle as a gas lock above the upper side of the catalyst beds, together with partial opening of the flow access to the catalyst refill volume; making flow through the catalyst bed from above possible.

For all of the structural modifications, the pressure loss, NH₃ concentration (% by vol. NH₃) at the outlet of the catalyst bed and the resultant additional annual production of NH₃ were calculated. The results are summarized in the following table:

Results of the structural modifications only to reactor 3:

| | | | | Additional |
|---|---|---|---|---|
| | Outlet | | | production |
| | T | Vol.-% | ΔP | of NH₃ |
| Geometry | [° C.] | NH₃ | [bar] | [t/a] |
| 3rd catalyst bed: reference | 457.16 | 15.83 | 0.40 | 0 |
| 3rd catalyst bed: without | 458.05 | 15.90 | 0.60 | 2354 |
| deflecting tube, instead | | | | |
| more catalyst, gas lock | | | | |
| 3rd catalyst bed: without | 458.15 | 15.91 | 0.61 | 2585 |
| deflecting tube, instead | | | | |
| more catalyst, differently | | | | |
| perforated plates at the | | | | |
| inlet and outlet of the | | | | |
| bed, gas lock | | | | |
| 3rd catalyst bed: without | 458.22 | 15.92 | 0.55 | 2780 |
| deflecting tube, instead | | | | |
| more catalyst, gas lock, | | | | |
| partial opening for the | | | | |
| flow from above | | | | |

Results of the structural modifications only to reactor 1:

| | | | Additional |
|---|---|---|---|
| | Outlet | | production |
| | T | % by vol. | of NH₃ |
| Geometry | [° C.] | NH₃ | [t/a] |
| 1st catalyst bed: reference | 506.50 | 9.73 | 0 |
| 1st catalyst bed: gas lock, partial | 508.14 | 9.84 | 3672 |
| opening for the flow from above | | | |

Results of the structural modifications to all three reactors:

| | | | Additional |
|---|---|---|---|
| | Outlet | | production |
| | T | % by vol. | of NH₃ |
| Geometry | [° C.] | NH₃ | [t/a] |
| 1st-3rd catalyst bed: reference | 457.16 | 15.83 | 0 |
| 3rd catalyst bed: without deflecting | 458.31 | 15.93 | 4182 |
| tube, instead more catalyst; also | | | |
| differently perforated plates at the | | | |
| inlet and outlet of the catalyst bed; | | | |
| 1st-3rd catalyst bed: gas lock, | | | |
| partial opening for the flow from | | | |
| above | | | |

As the results of the simulation calculations that are summarized above confirm, the annual production of NH3 can be increased considerably by the structural improvements according to the invention.

1.-17. (canceled)

18. A reactor for catalytic conversion of a gas mixture, the reactor comprising:
a vessel;
a catalyst bed disposed between a first lateral delimitation and a second lateral delimitation of the vessel, wherein the first lateral delimitation comprises a plurality of lateral gas inlets through which the gas mixture flows into the catalyst bed to at least partly react, wherein the second lateral delimitation comprises a plurality of lateral gas outlets through which the gas mixture flows out of the catalyst bed;
a gas lock that is movable in a vertical direction and is disposed along only a first part of an upper side of the catalyst bed; and
an upper gas inlet disposed along a second part of the upper side of the catalyst bed, wherein the second part of the upper side does not overlap with the first part of the upper side, wherein the gas mixture flows from above the upper gas inlet into the catalyst bed.

19. The reactor of claim 18 wherein the gas lock is lowered in the vertical direction by gravitational force when the catalyst bed contracts.

20. The reactor of claim 18 wherein an outer periphery of the gas lock lies flush against the second lateral delimitation.

21. The reactor of claim 18 wherein the gas lock comprises a plurality of segments that overlap horizontally.

22. The reactor of claim 21 wherein the plurality of segments are connected to one another movably such that the horizontal overlap of the plurality of segments is retained when the gas lock moves vertically.

23. The reactor of claim 18 wherein at least one of the first lateral delimitation or the second lateral delimitation comprises a perforated plate.

24. The reactor of claim 18 wherein the first lateral delimitation forms an outer cylinder and the second lateral delimitation forms an inner cylinder, wherein the inner cylinder is positioned concentrically within the outer cylinder and the outer cylinder is positioned concentrically within the vessel, wherein the catalyst bed is positioned between an inner side of a wall of the outer cylinder and an outer side of a wall of the inner cylinder, wherein the vessel has a substantially circular cross-section, wherein an annular gap exists between an inner side of a wall of the vessel and an outer side of the wall of the outer cylinder through which the gas mixture flows before entering the plurality of lateral gas inlets in the outer cylinder.

25. The reactor of claim 24 wherein the plurality of lateral gas inlets of the first lateral delimitation are disposed in the wall of the outer cylinder so that the gas mixture flows from the annular gap into the catalyst bed radially from a side via the plurality of lateral gas inlets through the wall of the outer cylinder, wherein the plurality of lateral gas inlets of the second lateral delimitation are disposed in the wall of the inner cylinder so that the gas mixture flows radially out of the catalyst bed through the plurality of lateral gas inlets in the wall of the inner cylinder and into an inner cavity formed by the inner cylinder and via which the gas mixture is dischargeable.

26. The reactor of claim 24 wherein the plurality of gas inlets in or along the wall of the outer cylinder differ in at least one of a number, a size, or a position than the plurality of gas inlets in or along the wall of the inner cylinder.

27. The reactor of claim 24 wherein the gas lock is configured as an annular disk with an inner periphery that lies flush against the outer side of the wall of the inner cylinder.

28. The reactor of claim 27 wherein both an outer periphery of the annular disk and the inner side of the wall of the outer cylinder have a substantially circular shape, with the outer periphery of the annular disk being smaller than the inner side of the wall of the outer cylinder, wherein a second annular gap that forms the upper gas inlet exists between the inner side of the wall of the outer cylinder and the outer periphery of the annular disk.

29. The reactor of claim 28 wherein the inner periphery of the annular disk is substantially circular and has a radius R₁, wherein the outer side of the wall of the inner cylinder is substantially circular and has a radius R₂, wherein a surface area F₁ of the annular disk in a main plan of extent follows F₁=π(R₂²−R₁²), wherein the inner side of the wall of the outer cylinder is substantially circular and has a radius R₃, wherein the surface area F₂ of the second annular gap follows F₂=π(R₃²−R₂²) and F₁ is greater than or equal to F₂.

30. The reactor of claim 27 wherein in an upper region of the inner cylinder against which the inner periphery of the annular disk lies, the inner cylinder at least one of
does not include a gas outlet, or
includes gas outlets that are closed in a flush manner by a concentrically arranged closure lying on an inside or an outside.

31. The reactor of claim 30 wherein an upper region of the outer cylinder comprises at least some of the plurality of lateral gas inlets, which is arranged substantially parallel to the upper region of the inner cylinder.

32. A method for catalytic ammonia synthesis, a gas mixture substantially comprising nitrogen and hydrogen being made to react under increased pressure and at increased temperature in a reactor as recited in claim 18.

33. An ammonia converter comprising at least two reactors arranged one above another in a common pressure vessel, each of the at least two reactors comprising:
a vessel;
a catalyst bed disposed between a first lateral delimitation and a second lateral delimitation of the vessel, wherein the first lateral delimitation comprises a plurality of lateral gas inlets through which the gas mixture flows into the catalyst bed to at least partly react, wherein the second lateral delimitation comprises a plurality of lateral gas outlets through which the gas mixture flows out of the catalyst bed;
a gas lock that is movable in a vertical direction and is disposed along only a first part of an upper side of the catalyst bed; and
an upper gas inlet disposed along a second part of the upper side of the catalyst bed, wherein the second part of the upper side does not overlap with the first part of the upper side, wherein the gas mixture flows from above the upper gas inlet into the catalyst bed,
wherein the first lateral delimitation forms an outer cylinder and the second lateral delimitation forms an inner cylinder, wherein the inner cylinder is positioned concentrically within the outer cylinder and the outer cylinder is positioned concentrically within the vessel, wherein the catalyst bed is positioned between an inner side of a wall of the outer cylinder and an outer side of a wall of the inner cylinder, wherein the vessel has a substantially circular cross-section, wherein an annular gap exists between an inner side of a wall of the vessel and an outer side of the wall of the outer cylinder through which the gas mixture flows before entering the plurality of lateral gas inlets in the outer cylinder.

34. A method for catalytic ammonia synthesis, a gas mixture substantially comprising nitrogen and hydrogen being made to react under increased pressure and at increased temperature in an ammonia converter as recited in claim 33.
